(19) United States
(12) Patent Application Publication
(10) Pub. No.: US 2026/0081211 A1
(43) Pub. Date: Mar. 19, 2026

(54) COMPOSITE ELECTROLYTE WITH WIDE WORKING VOLTAGE RANGE FOR ALL-SOLID-STATE LITHIUM-ION BATTERY, AND PREPARATION METHOD AND USE THEREOF

(71) Applicant: XI'AN TECHNOLOGICAL UNIVERSITY, Xi'an, Shaanxi (CN)

(72) Inventors: Hongge PAN, Xi'an, Shaanxi (CN); Zhenglong LI, Xi'an, Shaanxi (CN); Yaxiong YANG, Xi'an, Shaanxi (CN); Zhijun WU, Xi'an, Shaanxi (CN)

(21) Appl. No.: 18/869,916

(22) PCT Filed: Aug. 7, 2024
(86) PCT No.: PCT/CN2024/110248

§ 371 Date: Nov. 27, 2024

(30) Foreign Application Priority Data
Aug. 16, 2023 (CN) 202311029213.2

(51) Int. Cl. H01M 10/0562; H01M 4/38; H01M 4/525; H01M 10/0525; H01M 10/0565

(52) U.S. Cl. CPC H01M 10/0562; H01M 4/382; H01M 4/525; H01M 10/0525; H01M 10/0565; H01M 2300/0068; H01M 2300/0082; H01M 2300/0094

(57) ABSTRACT

Provided are a composite electrolyte with a wide working voltage range for an all-solid-state lithium-ion battery, and a preparation method and use thereof. The composite electrolyte includes a lithium borohydride-based solid-state electrolyte and a polymer coating layer coated on a surface of the lithium borohydride-based solid-state electrolyte. A voltage window of the composite electrolyte with the wide working voltage range is not less than 6 V and up to 10 V. The lithium borohydride-based solid-state electrolyte comprises lithium borohydride, alumina, and lithium iodide. The polymer coating layer is poly(methyl methacrylate). A mass percentage of the lithium borohydride-based solid-state electrolyte in the composite electrolyte with the wide working voltage range is in a range of 70 wt. % to 99 wt. %; and a mass percentage of the polymer coating layer in the composite electrolyte with the wide working voltage range is in a range of 1 wt. % to 30 wt. %.

### CROSS REFERENCE TO RELATED APPLICATION

The present application is a national stage application of International Patent Application No. PCT/CN2024/110248, filed on Aug. 7, 2024, which claims priority to Chinese Patent Application No. 202311029213.2 filed with the China National Intellectual Property Administration (CNIPA) on Aug. 16, 2023 and entitled “COMPOSITE ELECTROLYTE WITH WIDE WORKING VOLTAGE RANGE FOR ALL-SOLID-STATE LITHIUM-ION BATTERY, AND PREPARATION METHOD AND USE THEREOF”. The disclosure of the two applications is incorporated herein by reference in its entirety.

### TECHNICAL FIELD

The present disclosure relates to the field of all-solid-state lithium-ion batteries, and in particular to a composite electrolyte with a wide working voltage range for an all-solid-state lithium-ion battery, and a preparation method and use thereof.

### BACKGROUND

With the pursuit of high-energy-density energy-storage devices, lithium-ion batteries have received unprecedented attention. However, the traditional liquid lithium-ion batteries are faced with the following two key technical problems: low energy density and poor safety. Currently, these two problems can be solved by replacing liquid electrolytes with all-solid-state electrolytes. In addition, all-solid-state electrolytes can match both high-voltage positive electrode and lithium metal to allow higher energy density. However, most inorganic all-solid-state electrolytes have a narrow voltage window, such that corresponding all-solid-state lithium batteries undergo heavy oxidative decomposition at high voltage, resulting in serious performance deterioration.

As a solid-state electrolyte, lithium borohydride exhibits thermodynamic stability for the metal lithium. When lithium borohydride is used in an all-solid-state lithium-ion battery, there is no need to consider the interfacial reaction on the anode side. However, lithium borohydride-based solid-state electrolytes still have the following significant problems: 1. Due to the high local electron density of borohydride ions, it is prone to delocalization under the excitation of an external field, which results in the oxidation of anions and a narrow thermodynamic oxidation window of only 2.8 V for lithium borohydride. 2. The high electronic conductance in the bulk phase of a lithium borohydride-based solid-state electrolyte will lead to severe dendrite growth.

Currently, main methods for improving the voltage window of a lithium borohydride-based solid-state electrolyte are as follows: 1. Anions with strong electronegativity are introduced to improve the overall oxidative stability of borohydride ions. For example, lithium fluoride, lithium chloride, or the like is introduced. 2. Destroy or replace the structure of borohydride anion. For example, lithium borohydride is partially replaced with a high boride or a sulfide. The efforts to reduce electronic conductance have mainly focused on the introduction of an inert second phase with low electronic conductance such as alumina or silicon oxide into lithium borohydride to produce a compound including an ionic/covalent bond, such as ammonia borane. However, there is currently no systematic research and modification method to provide a lithium borohydride-based solid-state electrolyte capable of serving at high voltage and inhibiting the growth of dendrites, resulting in the failed commercial application of lithium borohydride-based solid-state electrolytes.

Therefore, the use of a simple and efficient method to comprehensively improve the voltage window and the dendrite growth-inhibiting ability of a lithium borohydride-based solid-state electrolyte is very necessary for the comprehensive performance improvement and large-scale commercial application of solid-state electrolytes.

### SUMMARY

In order to overcome the shortcoming that there is currently no systematic research and modification method to provide a lithium borohydride-based solid-state electrolyte capable of serving at high voltage and inhibiting the growth of dendrites, resulting in the failed commercial application of lithium borohydride-based solid-state electrolytes, the present disclosure provides a simple and efficient method to comprehensively improve the voltage window and the dendrite growth-inhibiting ability of a lithium borohydride-based solid-state electrolyte. A composite electrolyte prepared by the method can match the existing high-voltage lithium-ion battery, can adapt to a positive electrode material with higher working voltage in the future, and can greatly widen the working voltage window of a lithium-ion battery. Therefore, the present disclosure is of great significance for allowing the large-scale commercial application of solid-state electrolytes and improving the energy densities of lithium-ion batteries.

The present disclosure provides a composite electrolyte with a wide working voltage range for an all-solid-state lithium-ion battery, including a lithium borohydride-based solid-state electrolyte and a polymer coating layer coated on a surface of the lithium borohydride-based solid-state electrolyte, where
a voltage window of the composite electrolyte with the wide working voltage range is not less than 6 V and up to 10 V;
the lithium borohydride-based solid-state electrolyte includes lithium borohydride, alumina, and lithium iodide;
the polymer coating layer is poly(methyl methacrylate);
a mass percentage of the lithium borohydride-based solid-state electrolyte in the composite electrolyte with the wide working voltage range is in a range of 70 wt. % to 99 wt. %; and
a mass percentage of the polymer coating layer in the composite electrolyte with the wide working voltage range is in a range of 1 wt. % to 30 wt. %.

In some embodiments, with a total molar amount of the lithium borohydride, the alumina, and the lithium iodide in the lithium borohydride-based solid-state electrolyte as 100%, a molar amount of the lithium borohydride is 50% to 60% of the total molar amount, a molar amount of the alumina is 20% to 25% of the total molar amount, and a molar amount of the lithium iodide is 20% to 25% of the total molar amount.

In some embodiments, the polymer coating layer has a thickness of 1 nm to 100 nm.

In some embodiments, the poly(methyl methacrylate) has a polymerization degree of 250 to 20,000.

In some embodiments, the polymer coating layer is an amorphous coating layer.

In some embodiments, the composite electrolyte with the wide working voltage range includes covalent (OCH₃)ₓBH₄₋ₓ.

The present disclosure also provides a method for preparing the composite electrolyte with the wide working voltage range as described above, including:
subjecting the lithium borohydride, the alumina, the lithium iodide, and the poly(methyl methacrylate) to ball-milling to obtain a mixed powder,
subjecting the mixed powder to an in-situ melting reaction to obtain a product, and
collecting the product to obtain the composite electrolyte with the wide working voltage range.

In some embodiments, the ball-milling is conducted at a rotational speed of 530 rpm for 96 h;
a medium for the ball-milling is an agate, and a ball-to-powder ratio for the ball-milling is in a range of 100-800:1; and
an atmosphere for the ball-milling is an argon atmosphere.

In some embodiments, after the ball-milling, the method further includes sieving a resulting material.

In some embodiments, the in-situ melting reaction is conducted at a temperature of 130° C. to 180° C. and a pressure of 200 MPa to 500 MPa for 1 h to 5 h.

The present disclosure also provides use of the composite electrolyte with the wide working voltage range as described above or the composite electrolyte with the wide working voltage range prepared by the method as described above in an all-solid-state lithium-ion battery, where the all-solid-state lithium-ion battery includes a positive electrode, a negative electrode, and the composite electrolyte with the wide working voltage range.

The present disclosure also provides an all-solid-state lithium-ion battery, including a positive electrode, a negative electrode, and a composite electrolyte with a wide working voltage range, where
the composite electrolyte with the wide working voltage range is the composite electrolyte with the wide working voltage range as described above or the composite electrolyte with the wide working voltage range prepared by the method as described above.

In some embodiments, a material for the positive electrode includes lithium cobalt oxide; and
a material for the negative electrode includes a lithium metal.

Some embodiments of the present disclosure have the following advantages:
1. The composite electrolyte with the wide working voltage range can allow a stable voltage window of 0 V to 10 V and a critical current density as high as 21.65 mA cm⁻² at room temperature, and can complete 1,000 h continuous constant-voltage electroplating-peeling test at a high voltage of 10.0 V, indicating very prominent electrochemical stability.
2. When the composite electrolyte with the wide working voltage range is assembled with a lithium cobalt oxide positive electrode and a lithium metal negative electrode to produce an all-solid-state battery, the 200-cycle capacity retention rate can be as high as 100% in a voltage window of 3.0 V to 4.2 V, and the reversible and stable charge/discharge cycling performance can be allowed in a voltage window of 3.0 V to 5.0 V.
3. The method for preparing the composite electrolyte with the wide working voltage range is a two-step method including conventional high-energy ball-milling and an in-situ melting reaction. In the method, poly(methyl methacrylate) is induced to react with a lithium borohydride-based solid-state electrolyte to produce a covalent coordination compound (OCH₃)ₓBH₄₋ₓ, which thermodynamically improves the oxidative stability of BH₄⁻ anions and dynamically blocks the transport of electrons at the electrolyte particle interface, thereby finally allowing a wide voltage window and an excellent dendrite-inhibiting ability. The method does not introduce additional electrolyte preparation steps, does not cause additional preparation cost, involves simple operations and strong material preparation controllability, and is completely suitable for the needs of industrial production.

### BRIEF DESCRIPTION OF THE DRAWINGS

FIG. 1 is a transmission electron microscopy image of the composite electrolyte with a wide working voltage range prepared in Example 1;

FIG. 2A-2D show energy spectra of the composite electrolyte with a wide working voltage range prepared in Example 1;

FIG. 3A-3D show spectra of the composite electrolyte with a wide working voltage range prepared in Example 1, where FIG. 3A shows X-ray photoelectron spectroscopy (XPS) spectra of oxygen, FIG. 3B shows XPS spectra of boron, FIG. 3C shows ¹³carbon solid-state nuclear magnetic resonance spectra, and FIG. 3D shows ¹¹boron solid-state nuclear magnetic resonance spectra;

FIG. 4 shows the temperature dependent electron conductivity and ion conductivity of the composite electrolyte with a wide working voltage range prepared in Example 1 at a temperature of −30° C. to 150° C.;

FIG. 5 shows a cyclic voltammetry curve of the composite electrolyte with a wide working voltage range prepared in Example 1 in a voltage window;

FIG. 6A-6C show the electrochemical performance of a lithium cobalt oxide half-cell assembled using the composite electrolyte with a wide working voltage range prepared in Example 1 at a current density of 60 mA·g⁻¹, where FIG. 6A shows an initial charge-discharge curve in a voltage window of 3.0 V to 4.2 V, FIG. 6B shows a cycling performance curve at a current density of 12 mA·g⁻¹, and FIG. 6C shows a cycling performance curve in a voltage window of 3.0 V to 5.0 V;

FIG. 7A-7B show the critical current density at room temperature (FIG. 7A) and a continuous lithium electroplating-peeling curve at an applied voltage of 10.0 V (FIG. 7B) for a symmetric lithium battery assembled using the composite electrolyte with a wide working voltage range prepared in Example 1;

FIG. 8A-8B show ¹³carbon solid-state nuclear magnetic resonance spectra (FIG. 8A) and ¹¹boron solid-state nuclear magnetic resonance spectra (FIG. 8B) of the composite electrolyte with a wide working voltage range prepared in Example 2;

FIG. 9 shows a cyclic voltammetry curve of the composite electrolyte with a wide working voltage range prepared in Example 2 in a voltage window;

FIG. 10A-10C show the electrochemical performance of a lithium cobalt oxide half-cell assembled using the composite electrolyte with a wide working voltage range prepared in Example 2 at a current density of 60 mA·g⁻¹, where FIG. 10A shows an initial charge-discharge curve in a voltage window of 3.0 V to 4.2 V, FIG. 10B shows a cycling performance curve at a current density of 12 mA·g⁻¹, and FIG. 10C shows a cycling performance curve in a voltage window of 3.0 V to 5.0 V;

FIG. 11A-11B show the critical current density (FIG. 11A) at room temperature and a continuous lithium electroplating-peeling curve (FIG. 11B) at an applied voltage of 10.0 V for a symmetric lithium battery assembled using the composite electrolyte with a wide working voltage range prepared in Example 2;

FIG. 12 shows a cyclic voltammetry curve of the composite electrolyte with a wide working voltage range prepared in Example 3 in a voltage window;

FIG. 13A-13C show the electrochemical performance of a lithium cobalt oxide half-cell assembled using the composite electrolyte with a wide working voltage range prepared in Example 3 at a current density of 60 mA·g⁻¹, where FIG. 13A shows an initial charge-discharge curve in a voltage window of 3.0 V to 4.2 V, FIG. 13B shows a cycling performance curve at a current density of 12 mA·g⁻¹, and FIG. 13C shows a cycling performance curve in a voltage window of 3.0 V to 5.0 V;

FIG. 14A-14B show the critical current density (FIG. 14A) at room temperature and a continuous lithium electroplating-peeling curve (FIG. 14B) at an applied voltage of 10.0 V for a symmetric lithium battery assembled using the composite electrolyte with a wide working voltage range prepared in Example 3;

FIG. 15 shows a cyclic voltammetry curve of the composite electrolyte with a wide working voltage range prepared in Example 4 in a voltage window;

FIG. 16A-16B show the electrochemical performance of a lithium cobalt oxide half-cell assembled using the composite electrolyte with a wide working voltage range prepared in Example 4 at a current density of 60 mA·g⁻¹, where FIG. 16A shows an initial charge-discharge curve in a voltage window of 3.0 V to 4.2 V and FIG. 16B shows a cycling performance curve;

FIG. 17 shows a cyclic voltammetry curve of the solid-state electrolyte prepared in Comparative Example 1 in a voltage window;

FIG. 18A-18B show the electrochemical performance of a lithium cobalt oxide half-cell assembled using the solid-state electrolyte prepared in Comparative Example 1 at a current density of 60 mA·g⁻¹, where FIG. 18A shows an initial charge-discharge curve in a voltage window of 3.0 V to 4.2 V and FIG. 18B shows a cycling performance curve;

FIG. 19 shows the critical current density at room temperature of a symmetric lithium battery assembled using the solid-state electrolyte prepared in Comparative Example 1;

FIG. 20 shows a cyclic voltammetry curve of the solid-state electrolyte prepared in Comparative Example 2 in a voltage window;

FIG. 21A-21B show the electrochemical performance of a lithium cobalt oxide half-cell assembled using the solid-state electrolyte prepared in Comparative Example 2 at a current density of 60 mA·g⁻¹, where FIG. 21A shows a charge-discharge curve in a voltage window of 3.0 V to 4.2 V and FIG. 21B shows a cycling performance curve; and

FIG. 22 shows the critical current density at room temperature of a symmetric lithium battery assembled using the solid-state electrolyte prepared in Comparative Example 2.

### DETAILED DESCRIPTION OF THE EMBODIMENTS

The present disclosure is further illustrated below in conjunction with specific examples. These examples are merely intended to describe the present disclosure, rather than to limit the scope of the present disclosure.

### Example 1

A lithium borohydride-based solid-state electrolyte consisting of 25% of alumina, 25% of lithium iodide, and 50% of lithium borohydride in molar percentages was adopted, and poly(methyl methacrylate) with a polymerization degree of 10,000 was adopted. The lithium borohydride-based solid-state electrolyte and the poly(methyl methacrylate) were subjected to high-energy ball-milling to obtain a ball-milled product. A mass ratio of the lithium borohydride-based solid-state electrolyte to the poly(methyl methacrylate) was 95:5. The ball-milled product was sieved to obtain a mixed powder. Then, the mixed powder was subjected to an in-situ melting reaction to obtain a final composite electrolyte. The in-situ melting reaction was conducted at a temperature of 150° C. and a constant pressure of 300 MPa for 1 h.

The electrochemical performance of the composite electrolyte prepared in this example was characterized by a solid-state battery test mold. A solid-state battery was assembled in an argon-filled glove box with both water and oxygen contents of less than 0.1 ppm. Lithium electroplating-peeling cycle test was conducted with a symmetric lithium battery in which electrode materials at two sides both were lithium alloy. The voltage window was tested by a half-cell cyclic voltammetry test, where a lithium foil was adopted at a single side and a lithium cobalt oxide positive electrode was adopted at a counter electrode side. The electrochemical performance of a half-cell was tested by a constant-current charge-discharge test.

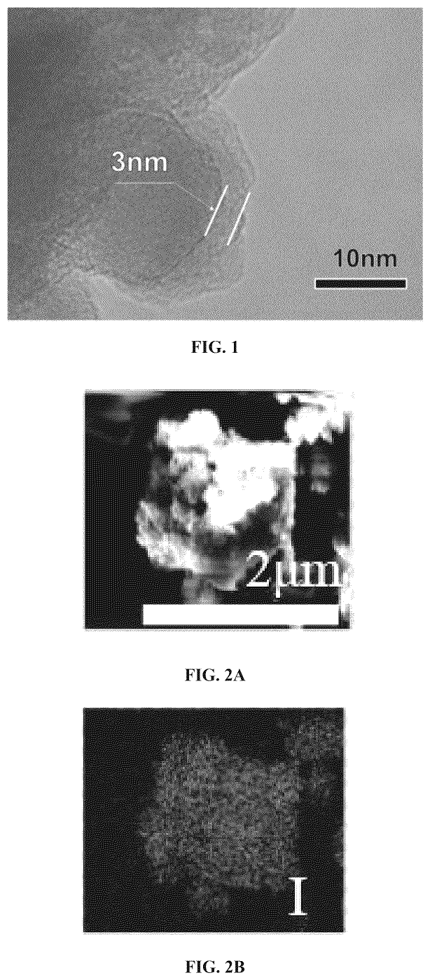

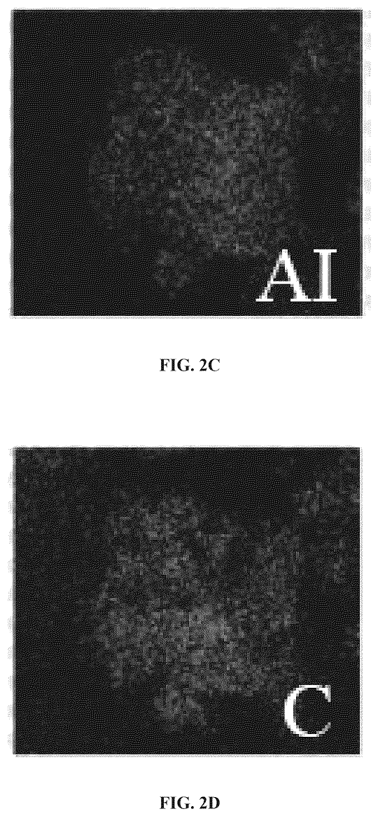

The morphology of the composite electrolyte prepared in this example was characterized. A high-resolution transmission electron microscopy image of the composite electrolyte is shown in FIG. 1, and it can be seen from this image that there is a uniform amorphous coating layer with a thickness of about 3 nm on the surface of the composite electrolyte in this example. The amorphous coating layer was further subjected to energy spectroscopy (FIG. 2A-2D), and it can be seen that carbon, iodine, and aluminum are uniformly distributed on the secondary particle surface of the composite electrolyte. Because carbon is derived from the poly(methyl methacrylate), it indicates that the poly(methyl methacrylate) was coated on the surface of the lithium borohydride-based solid-state electrolyte.

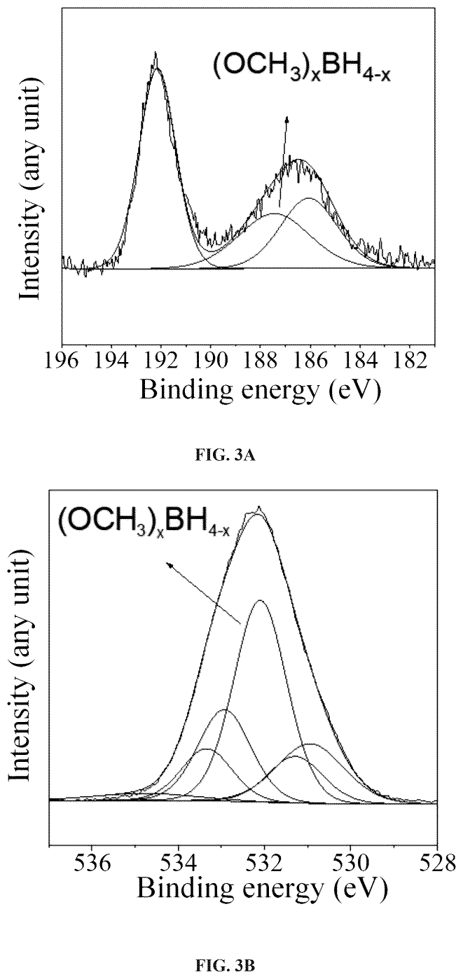

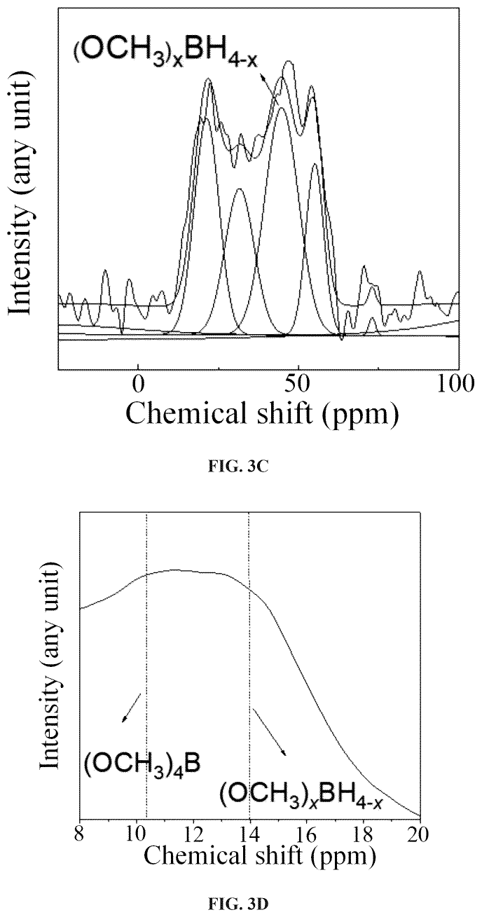

FIG. 3A shows XPS spectra of O1s of the composite electrolyte and FIG. 3B shows XPS spectra of Bls of the composite electrolyte. XPS results show that the product obtained after the in-situ melting reaction has a completely-new phase composition: (OCH₃)ₓBH₄₋ₓ. FIG. 3C shows ¹³carbon solid-state nuclear magnetic resonance spectra of the composite electrolyte, and it can be seen that there is a shielding effect on ¹³carbon, which corresponds to a covalent B—O bond partially formed in (OCH₃)ₓBH₄₋ₓ. FIG. 3D shows ¹¹B solid-state nuclear magnetic resonance spectra of the composite electrolyte, and it can be seen that there are two characteristic peaks corresponding to (OCH₃)₄B and (OCH₃)ₓBH₄₋ₓ. In summary, covalent (OCH₃)ₓBH₄₋ₓ is produced in the composite electrolyte obtained after the high-energy ball-milling and the in-situ melting reaction.

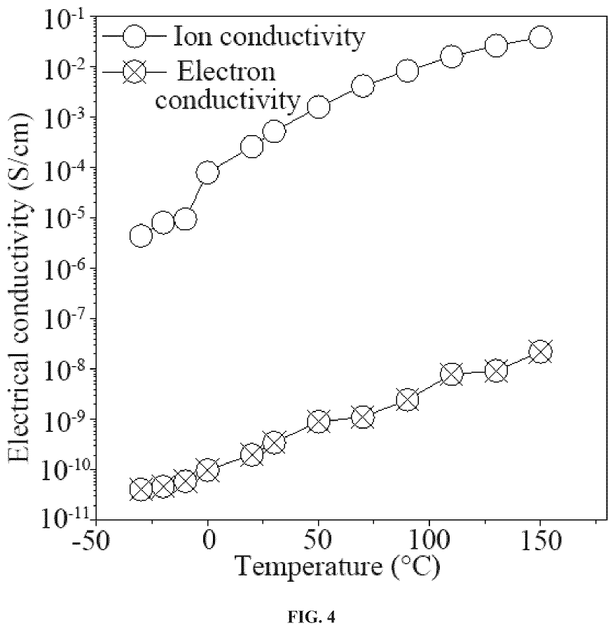

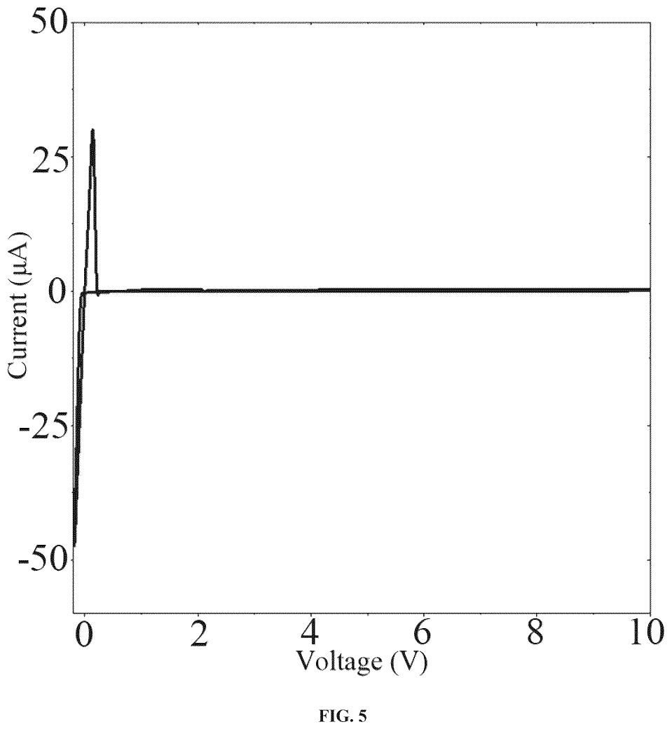

FIG. 4 shows the temperature dependent electronic conductance and ionic conductance of the composite electrolyte in this example at a temperature of −30° C. to 150° C. The results show that the composite electrolyte has an electron conductivity of merely 4×10⁻¹⁰ S·cm⁻² and an ion conductivity of 5.1×10⁻⁴ S·cm⁻² at room temperature. Most importantly, the electron conductivity of the composite electrolyte remains 6 to 7 orders of magnitude smaller than the ion conductivity of the composite electrolyte in the whole temperature range.

FIG. 5 shows a cyclic voltammetry curve of the composite electrolyte in this example in a voltage window. The results show that the composite electrolyte can provide a stable voltage window of 0 V to 10.0 V at room temperature, and has a maximum oxidative decomposition current of merely 0.85 μA. The results show that the composite electrolyte synthesized in this example exhibits excellent electrochemical stability at ultra-high voltage.

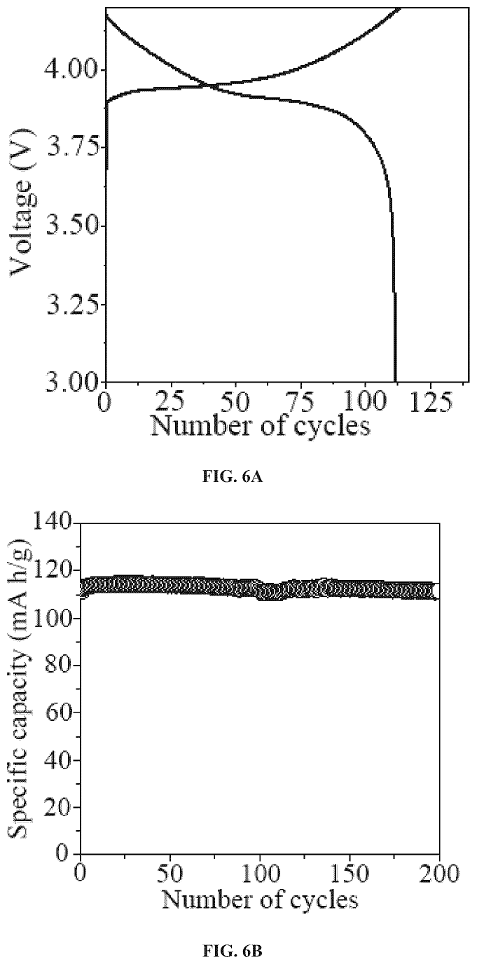

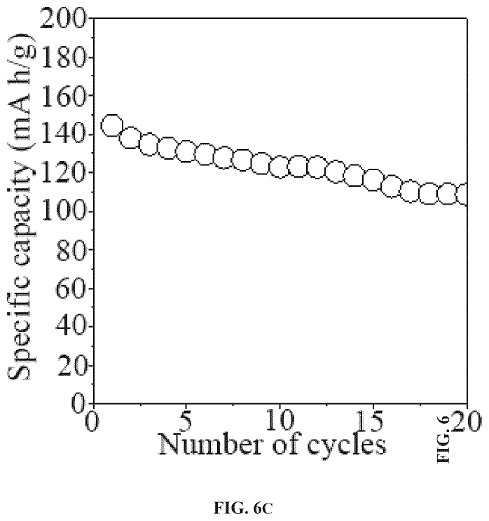

FIG. 6A shows a charge-discharge curve of a lithium cobalt oxide half-cell assembled using the composite electrolyte in this example at a current density of 60 mA·g⁻¹ in a voltage window of 3.0 V to 4.2 V, and it can be seen that the initial specific discharge capacity of the lithium cobalt oxide half-cell is 111.20 mA·g⁻¹. FIG. 6B shows a cycling performance curve of a lithium cobalt oxide half-cell assembled using the composite electrolyte in this example at a current density of 60 mA·g⁻¹, and it can be seen that the composite electrolyte can maintain a stable capacity during a long-cycling process and allow a capacity retention rate as high as 100% after 200 cycles. FIG. 6C shows a cycling performance curve of a lithium cobalt oxide half-cell assembled using the composite electrolyte in this example at a current density of 12 mA·g⁻¹ in a voltage window of 3.0 V to 5.0 V. The results show that the lithium cobalt oxide half-cell has an initial specific discharge capacity as high as 149.60 mA·g⁻¹ and can maintain stable reversible charge-discharge cycles within 20 cycles.

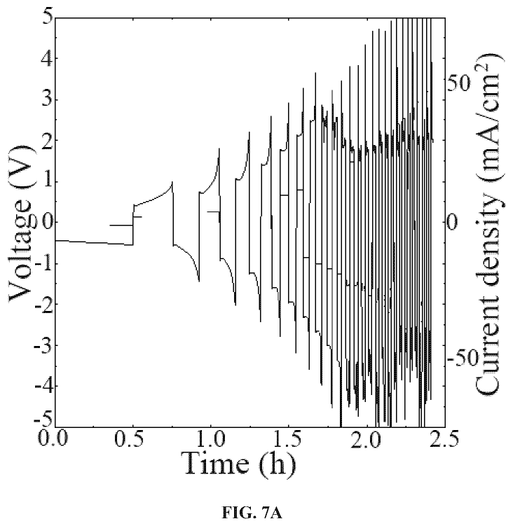

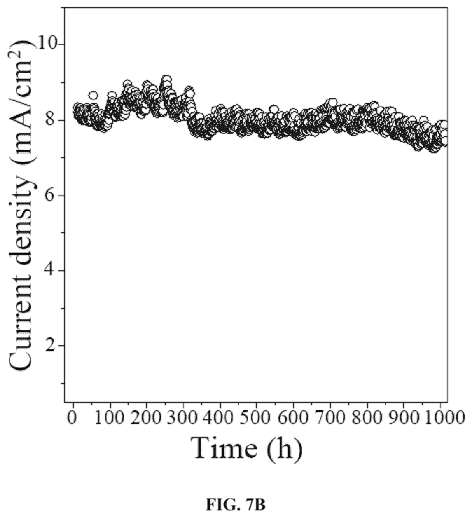

FIG. 7A shows a test curve of the critical current density of a symmetric lithium battery assembled using the composite electrolyte in this example at room temperature, and it can be seen that the critical current density of the symmetric lithium battery at room temperature is as high as 21.65 mA·cm⁻². FIG. 7B shows a continuous lithium electroplating-peeling curve at an applied voltage of 10.0 V of a symmetric lithium battery assembled using the composite electrolyte in this example. The results show that the composite electrolyte in this example can still be cycled with a stable overpotential after 1,000 h electroplating-peeling test, and there is no short-circuit tendency.

The above conclusions prove that the composite electrolyte in this example exhibits excellent dendrite-inhibiting performance in a very wide voltage window, and is a composite electrolyte with a wide working voltage range.

### Example 2

A method for preparing a composite electrolyte in this example was basically the same as that in Example 1 except that the in-situ melting reaction was conducted at 130° C. Assembly and testing processes of all-solid-state lithium-ion batteries in this example were the same as those in Example 1.

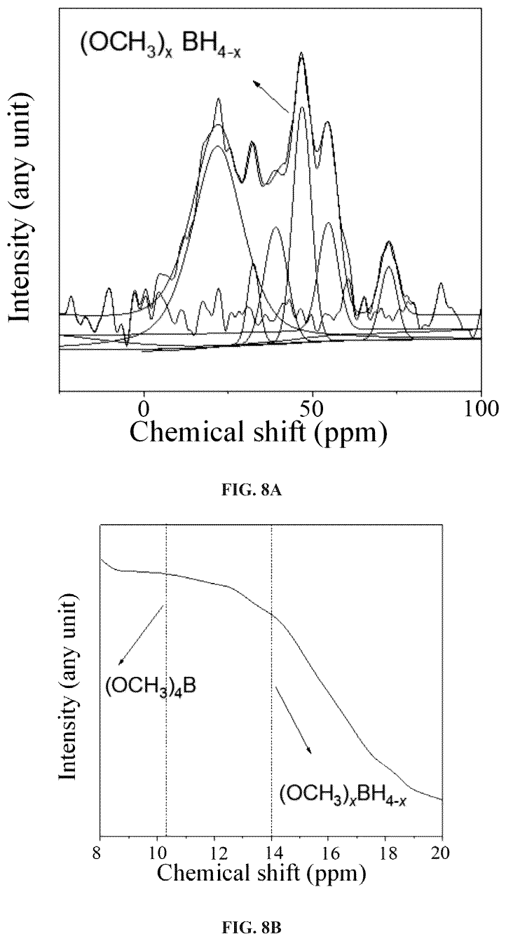

FIG. 8A shows ¹³carbon solid-state nuclear magnetic resonance spectra of the composite electrolyte in this example. The results show that, similar to the composite electrolyte in Example 1, there is a shielding effect on ¹³carbon, which corresponds to a (OCH₃)ₓBH₄₋ₓ compound. FIG. 8B shows ¹¹boron solid-state nuclear magnetic resonance spectra of the composite electrolyte, and it can be seen that there are two characteristic peaks corresponding to (OCH₃)₄B and (OCH₃)ₓBH₄₋ₓ. This example was different from Example 1 merely in chemical shifts, indicating different degrees of B—O coordination.

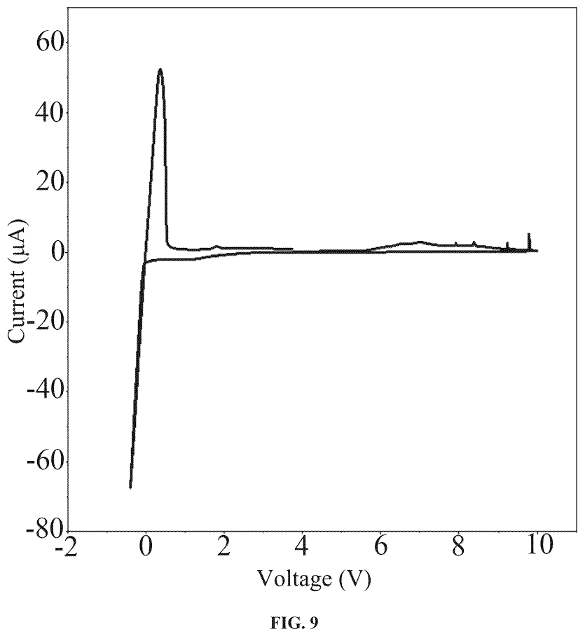

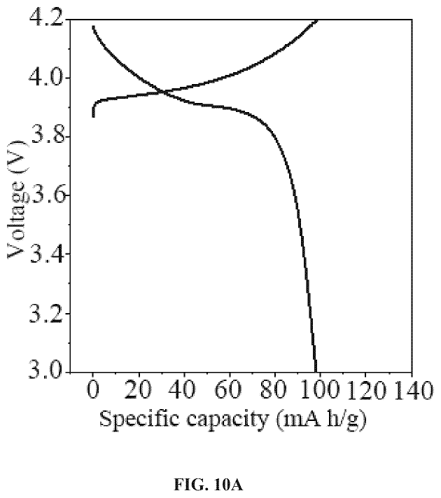

FIG. 9 shows a cyclic voltammetry curve of the composite electrolyte in this example in a voltage window. It can be seen that the composite electrolyte can provide a stable voltage window of 0 V to 6.0 V at room temperature, and has a maximum oxidative decomposition current of merely 6.85 μA. In summary, the composite electrolyte synthesized in this example has a similar stable high-voltage window to the composite electrolyte in Example 1.

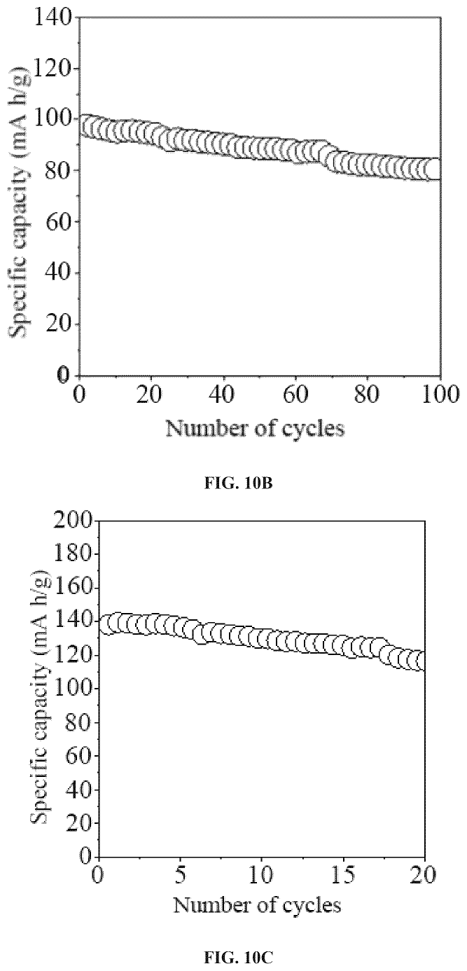

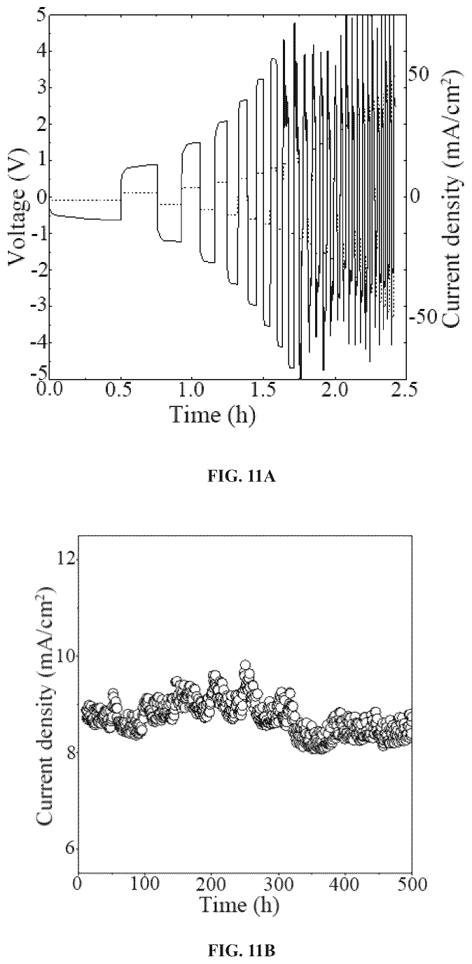

FIG. 10A shows a charge-discharge curve of a lithium cobalt oxide half-cell assembled using the composite electrolyte in this example at a current density of 60 mA·g⁻¹ in a voltage window of 3.0 V to 4.2 V, and it can be seen that the initial specific discharge capacity of the lithium cobalt oxide half-cell is 98.00 mA·h·g⁻¹. FIG. 10B shows a cycling performance curve of a lithium cobalt oxide half-cell assembled using the composite electrolyte in this example at a current density of 60 mA·g⁻¹, and it can be seen that the composite electrolyte can maintain a stable capacity during a long-cycling process and allow a capacity retention rate as high as 81.60% after 100 cycles. FIG. 10C shows a cycling performance curve of a lithium cobalt oxide half-cell assembled using the composite electrolyte in this example at a current density of 12 mA·g⁻¹ in a voltage window of 3.0 V to 5.0 V. The results show that the initial specific discharge capacity of the lithium cobalt oxide half-cell is as high as 137.60 mA·h·g⁻¹ and can still maintain stable reversible cycles within 20 cycles.

FIG. 11A shows a test curve of the critical current density of a symmetric lithium battery assembled using the composite electrolyte in this example at room temperature, and it can be seen that the critical current density of the symmetric lithium battery is 16.60 mA·cm⁻². FIG. 11B shows a continuous electroplating-peeling curve at an applied voltage of 10 V of a symmetric lithium battery assembled using the composite electrolyte in this example. It can be seen from this figure that the composite electrolyte in this example is similar to the composite electrolyte in Example 1. The composite electrolyte in this example can still be cycled with a stable overpotential after 500 h electroplating-peeling test, and there is no short-circuit tendency.

In summary, it indicates that the composite electrolyte synthesized in this example is a composite electrolyte with a wide working voltage range similar to the composite electrolyte in Example 1.

### Example 3

A method for preparing a composite electrolyte in this example was basically the same as that in Example 1 except that the in-situ melting reaction was conducted for 2 h. Assembly and testing processes of all-solid-state lithium-ion batteries in this example were the same as those in Example 1.

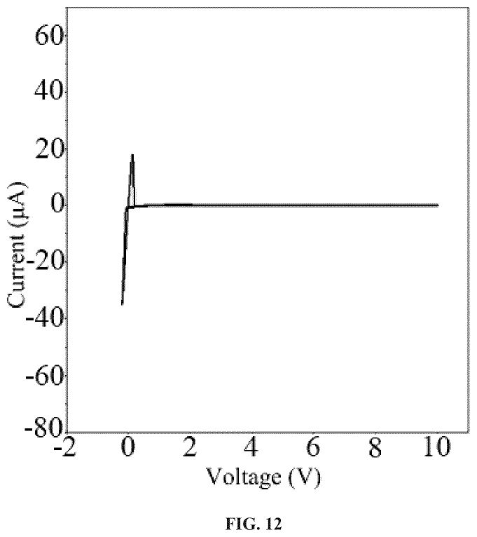

FIG. 12 shows a cyclic voltammetry curve of the composite electrolyte in this example in a voltage window. It can be seen that the composite electrolyte can provide a stable voltage window of 0 V to 10.0 V at room temperature and has a maximum oxidative decomposition current of merely 1.85 μA, indicating that the composite electrolyte synthesized in this example has a similar stable voltage window to the composite electrolyte in Example 1.

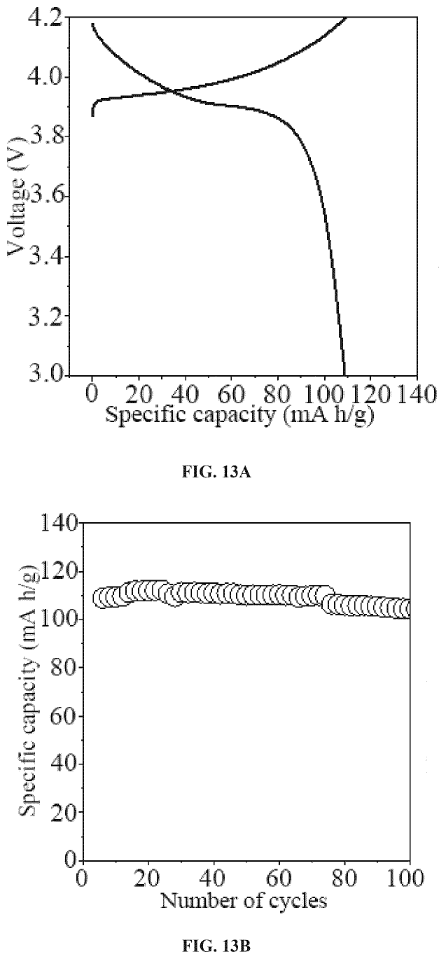

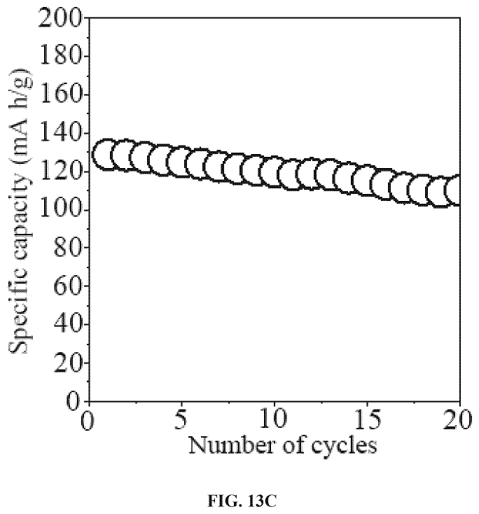

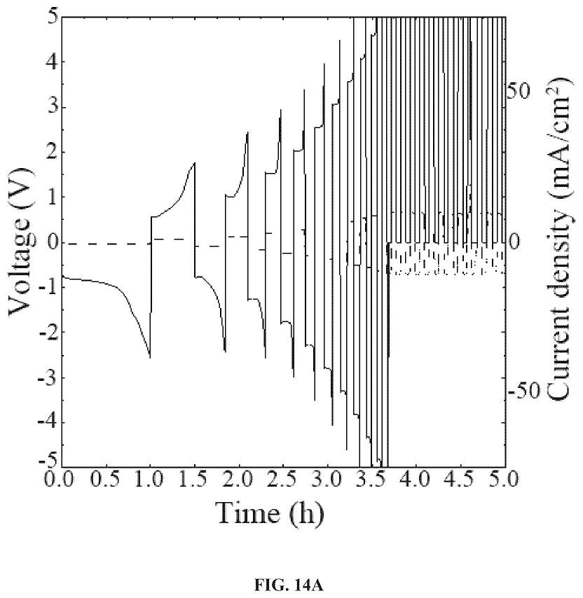

FIG. 13A shows a charge-discharge curve of a lithium cobalt oxide half-cell assembled using the composite electrolyte in this example at a current density of 60 mA·g⁻¹ in a voltage window of 3.0 V to 4.2 V, and it can be seen that the initial specific discharge capacity of the lithium cobalt oxide half-cell is 109.50 mA·h·g⁻¹. FIG. 13B shows a cycling performance curve of a lithium cobalt oxide half-cell assembled using the composite electrolyte in this example at a current density of 60 mA·g⁻¹, and it can be seen that the composite electrolyte can maintain a stable capacity during a long-cycling process and allow a capacity retention rate as high as 94.20% after 100 cycles. FIG. 13C shows a cycling performance curve of a lithium cobalt oxide half-cell assembled using the composite electrolyte in this example at a current density of 12 mA·g⁻¹ in a voltage window of 3.0 V to 5.0 V. The results show that the initial specific discharge capacity of the lithium cobalt oxide half-cell is as high as 129.60 mA·h·g⁻¹ and can still maintain stable reversible cycles within 20 cycles.

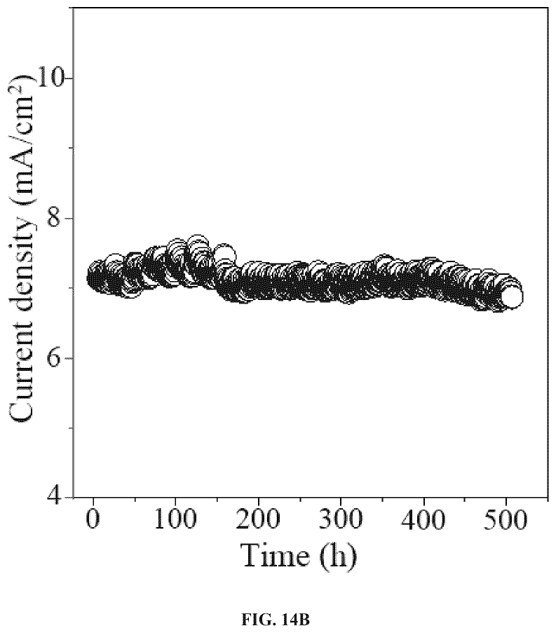

FIG. 14A shows a test curve of the critical current density of a symmetric lithium battery assembled using the composite electrolyte in this example at room temperature, and it can be seen that the critical current density of the symmetric lithium battery is 18.50 mA·cm⁻². FIG. 14B shows a continuous lithium electroplating-peeling curve at an applied voltage of 10 V of a symmetric lithium battery assembled using the composite electrolyte in this example. The results show that the composite electrolyte in this example is similar to the composite electrolyte in Example 1. The composite electrolyte in this example can still be cycled with a stable overpotential after 500 h electroplating-peeling test, and there is no short-circuit tendency.

In summary, it indicates that the composite electrolyte synthesized in this example is a composite electrolyte with a wide working voltage range similar to the composite electrolyte in Example 1.

### Example 4

A method for preparing a composite electrolyte in this example was basically the same as that in Example 1 except that the in-situ melting reaction was conducted at a pressure of 250 MPa. Assembly and testing processes of all-solid-state lithium-ion batteries in this example were the same as those in Example 1.

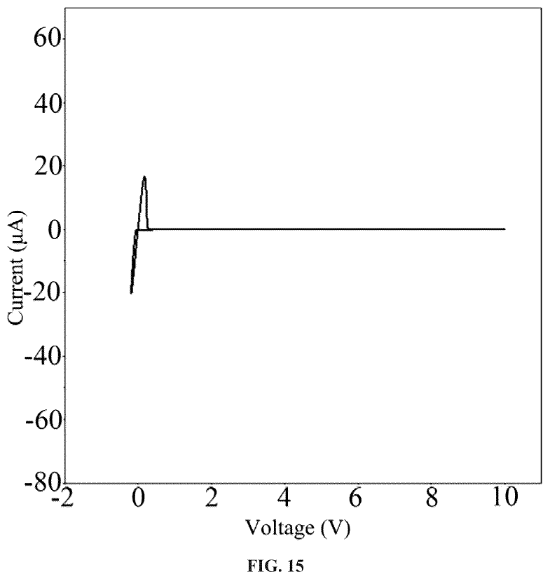

FIG. 15 shows a cyclic voltammetry curve of the composite electrolyte in this example in a voltage window. It can be seen that the composite electrolyte can provide a stable voltage window of 0 V to 10.0 V at room temperature, and has a maximum oxidative decomposition current of merely 1.15 μA. The composite electrolyte synthesized in this example has a similar stable voltage window to the composite electrolyte in Example 1.

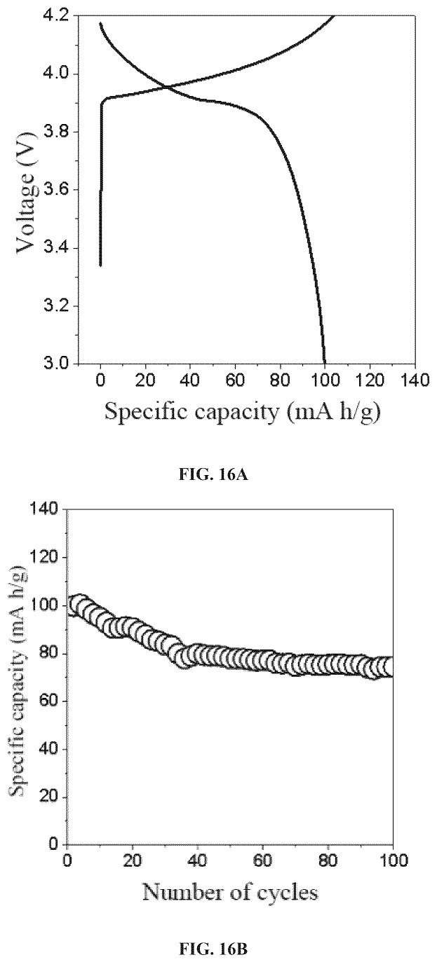

FIG. 16A shows a charge-discharge curve of a lithium cobalt oxide half-cell assembled using the composite electrolyte in this example at a current density of 60 mA·g⁻¹ in a voltage window of 3.0 V to 4.2 V, and it can be seen that the initial specific discharge capacity of the lithium cobalt oxide half-cell is 99.00 mA·h·g⁻¹. FIG. 16B shows a cycling performance curve of a lithium cobalt oxide half-cell assembled using the composite electrolyte in this example at a current density of 60 mA·g⁻¹. It can be seen that the composite electrolyte can maintain a stable capacity during a long-cycling process and allow a capacity retention rate as high as 74.4% after 100 cycles.

In summary, it indicates that the composite electrolyte synthesized in this example is a composite electrolyte with a wide working voltage range similar to the composite electrolyte in Example 1.

### Comparative Example 1

A method for preparing a solid-state electrolyte in this comparative example was basically the same as that in Example 1 except that the in-situ melting reaction was not adopted and a ball-milled powder was pressed into the solid-state electrolyte merely at a pressure of 300 MPa. Assembly and testing processes of all-solid-state lithium-ion batteries in this comparative example were the same as those in Example 1.

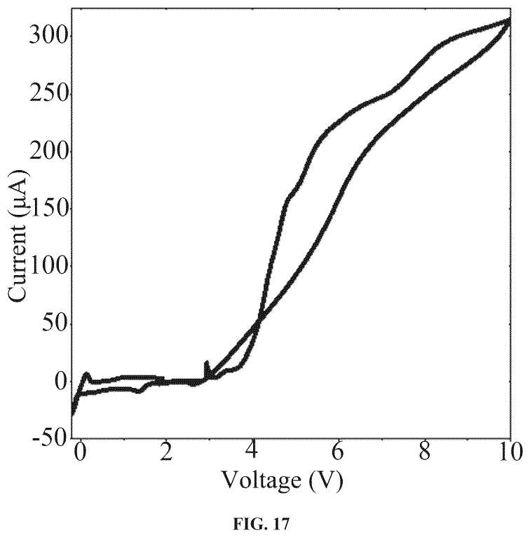

FIG. 17 shows a cyclic voltammetry curve of the solid-state electrolyte in this comparative example in a voltage window. It can be seen that the solid-state electrolyte has undergone severe oxidation under 2.8 V at room temperature and has a maximum oxidative decomposition current as high as 316.20 μA, indicating that the solid-state electrolyte synthesized in this comparative example has a narrow voltage window and is extremely unstable at high voltage.

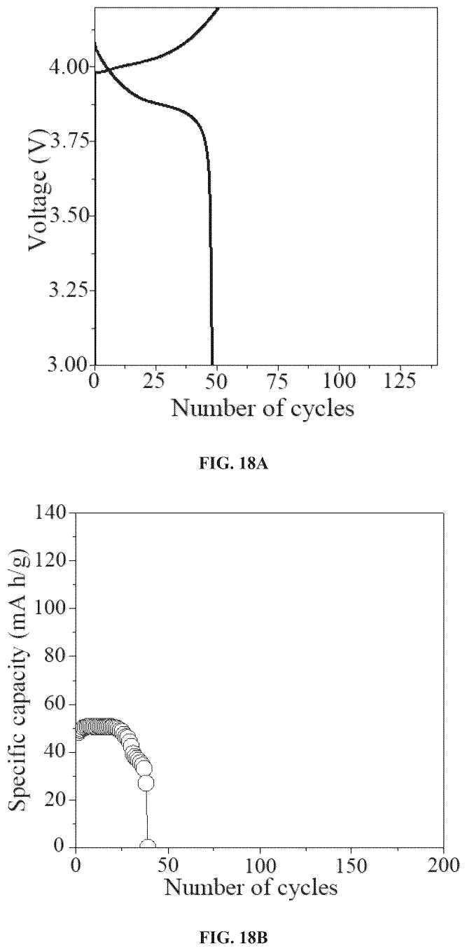

FIG. 18A shows a charge-discharge curve of a lithium cobalt oxide half-cell assembled using the solid-state electrolyte in this comparative example at a current density of 60 mA·g⁻¹ in a voltage window of 3.0 V to 4.2 V, and it can be seen that the initial specific discharge capacity of the lithium cobalt oxide half-cell is 48.00 mA·h·g⁻¹. FIG. 18B shows a cycling performance curve of a lithium cobalt oxide half-cell assembled using the solid-state electrolyte in this comparative example at a current density of 60 mA·g⁻¹. It can be seen that the lithium cobalt oxide half-cell fails after 40 cycles, indicating that the electrochemical performance of the solid-state electrolyte synthesized in this comparative example is significantly inferior to the electrochemical performance of the composite electrolyte in Example 1.

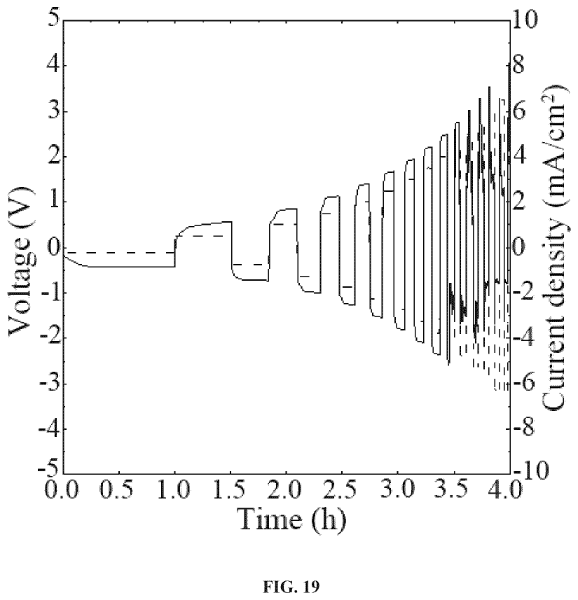

FIG. 19 shows a test curve of the critical current density of a symmetric lithium battery assembled using the solid-state electrolyte in this comparative example at room temperature, and it can be seen that the critical current density of the symmetric lithium battery is 3.85 mA·cm⁻².

In summary, the solid-state electrolyte obtained in this comparative example has a narrow voltage window and a small critical current density, cannot match the working voltage of a lithium cobalt oxide positive electrode, and is not a composite electrolyte with a wide working voltage range.

### Comparative Example 2

A method for preparing a solid-state electrolyte in this comparative example was basically the same as that in Example 1 except that, during the high-energy ball-milling, poly(methyl methacrylate) was not added to coat a lithium borohydride-based solid-state electrolyte. Assembly and testing processes of all-solid-state lithium-ion batteries in this comparative example were the same as those in Example 1.

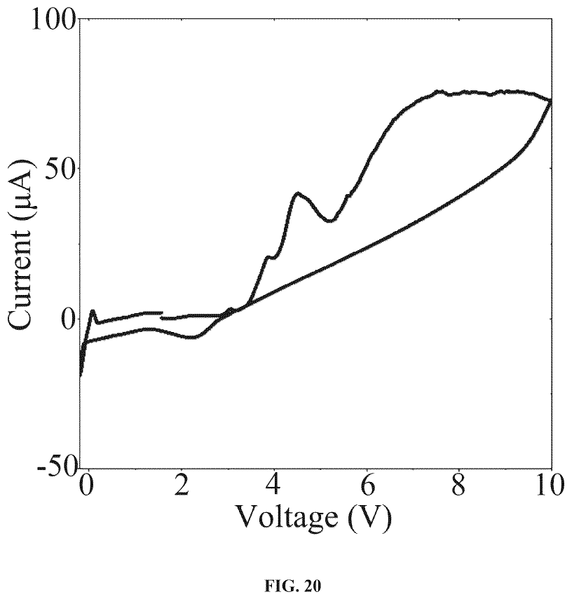

FIG. 20 shows a cyclic voltammetry curve of the solid-state electrolyte in this comparative example in a voltage window. It can be seen that the solid-state electrolyte has undergone severe oxidation under 2.7 V at room temperature and has a maximum oxidative decomposition current as high as 74.50 μA, indicating that the solid-state electrolyte synthesized in this comparative example has a narrow voltage window and is extremely unstable at high voltage.

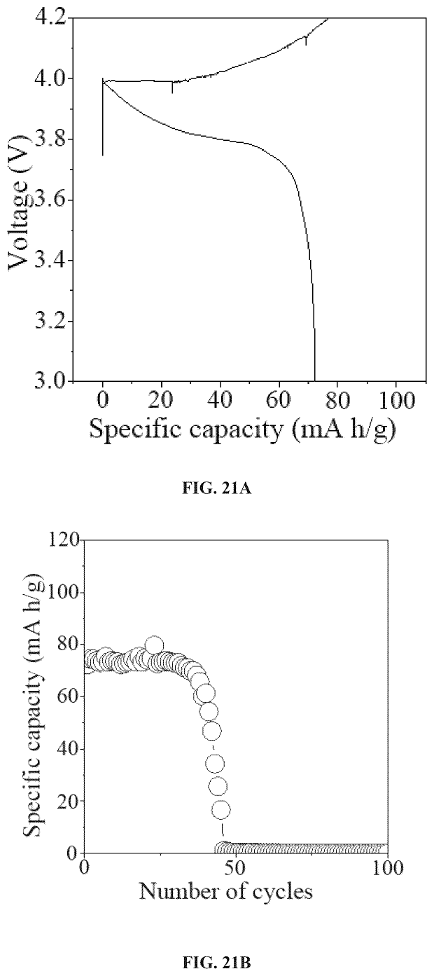

FIG. 21A shows a charge-discharge curve of a lithium cobalt oxide half-cell assembled using the solid-state electrolyte in this comparative example at a current density of 60 mA·g⁻¹ in a voltage window of 3.0 V to 4.2 V, and it can be seen that the initial specific discharge capacity of the lithium cobalt oxide half-cell is 72.00 mA·h·g⁻¹. FIG. 21B shows a cycling performance curve of a lithium cobalt oxide half-cell assembled using the solid-state electrolyte in this comparative example at a current density of 60 mA·g⁻¹. It can be seen that a significant capacity decline begins after 20 cycles, indicating that the electrochemical performance of the solid-state electrolyte synthesized in this comparative example is significantly inferior to the electrochemical performance of the composite electrolyte in Example 1.

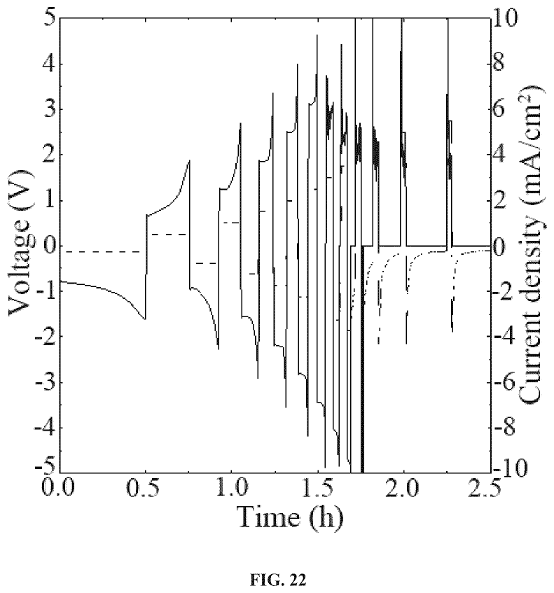

FIG. 22 shows a test curve of the critical current density of a symmetric lithium battery assembled using the solid-state electrolyte in this comparative example at room temperature, and it can be seen that the critical current density of the symmetric lithium battery is 3.15 mA·cm⁻².

In summary, the solid-state electrolyte obtained in this comparative example has a narrow voltage window and a small critical current density, cannot match the working voltage of a lithium cobalt oxide positive electrode, and is not a composite electrolyte with a wide working voltage range.

### Comparative Example 3

A method for preparing a solid-state electrolyte in this comparative example was basically the same as that in Example 1 except that, during the high-energy ball-milling, poly(methyl methacrylate) was not added to coat a lithium borohydride-based solid-state electrolyte, and a ball-milled powder was pressed into the solid-state electrolyte merely at a pressure of 300 MPa without an in-situ melting reaction. Assembly and testing processes of all-solid-state lithium-ion batteries in this comparative example were the same as those in Example 1.

During the test, the solid-state electrolyte in this comparative example underwent a serious oxidation reaction and a serious chemical reaction with lithium cobalt oxide, such that the intrinsic electrochemical stability of the solid-state electrolyte was deteriorated and it was impossible to complete the test normally. Therefore, the solid-state electrolyte in this comparative example cannot be used as a solid-state electrolyte for an all-solid-state lithium-ion battery.

The above examples and comparative examples are intended to describe the preferred embodiments of the present disclosure in detail, but the present disclosure is not limited thereto. Within the scope of the technical concept of the present disclosure, various simple variations can be made to the technical solutions of the present disclosure, including combinations of various technical features in any other appropriate way. These simple variations and combinations shall also be regarded as the contents disclosed in the present disclosure and shall fall within the scope of the present disclosure.

1. A composite electrolyte with a wide working voltage range for an all-solid-state lithium-ion battery, comprising a lithium borohydride-based solid-state electrolyte and a polymer coating layer coated on a surface of the lithium borohydride-based solid-state electrolyte, wherein
a voltage window of the composite electrolyte with the wide working voltage range is not less than 6 V and up to 10 V;
the lithium borohydride-based solid-state electrolyte comprises lithium borohydride, alumina, and lithium iodide;
the polymer coating layer is poly(methyl methacrylate);
a mass percentage of the lithium borohydride-based solid-state electrolyte in the composite electrolyte with the wide working voltage range is in a range of 70 wt. % to 99 wt. %; and
a mass percentage of the polymer coating layer in the composite electrolyte with the wide working voltage range is in a range of 1 wt. % to 30 wt. %.

2. The composite electrolyte with the wide working voltage range according to claim 1, wherein with a total molar amount of the lithium borohydride, the alumina, and the lithium iodide in the lithium borohydride-based solid-state electrolyte as 100%, a molar amount of the lithium borohydride is 50% to 60% of the total molar amount, a molar amount of the alumina is 20% to 25% of the total molar amount, and a molar amount of the lithium iodide is 20% to 25% of the total molar amount.

3. The composite electrolyte with the wide working voltage range according to claim 1, wherein the polymer coating layer has a thickness of 1 nm to 100 nm.

4. The composite electrolyte with the wide working voltage range according to claim 1, wherein the poly(methyl methacrylate) has a polymerization degree of 250 to 20,000.

5. The composite electrolyte with the wide working voltage range according to claim 1, wherein the polymer coating layer is an amorphous coating layer.

6. The composite electrolyte with the wide working voltage range according to claim 1, wherein the composite electrolyte with the wide working voltage range comprises covalent (OCH₃)ₓBH₄₋ₓ.

7. A method for preparing the composite electrolyte with the wide working voltage range according to claim 1, comprising:
subjecting the lithium borohydride, the alumina, the lithium iodide, and the poly(methyl methacrylate) to ball-milling to obtain a mixed powder,
subjecting the mixed powder to an in-situ melting reaction to obtain a product, and
collecting the product to obtain the composite electrolyte with the wide working voltage range.

8. The method according to claim 7, wherein the ball-milling is conducted at a rotational speed of 530 rpm for 96 h;
a medium for the ball-milling is an agate, and a ball-to-powder ratio for the ball-milling is in a range of 100-800:1; and
an atmosphere for the ball-milling is an argon atmosphere.

9. The method according to claim 7, wherein after the ball-milling, the method further comprises sieving a resulting material.

10. The method according to claim 7, wherein the in-situ melting reaction is conducted at a temperature of 130° C. to 180° C. and a pressure of 200 MPa to 500 MPa for 1 h to 5 h.

11. (canceled)

12. An all-solid-state lithium-ion battery, comprising a positive electrode, a negative electrode, and a composite electrolyte with a wide working voltage range, wherein
the composite electrolyte with the wide working voltage range is the composite electrolyte with the wide working voltage range according to claim 1.

13. The all-solid-state lithium-ion battery according to claim 12, wherein a material for the positive electrode comprises lithium cobalt oxide; and
a material for the negative electrode comprises a lithium metal.

14. The composite electrolyte with the wide working voltage range according to claim 3, wherein the poly(methyl methacrylate) has a polymerization degree of 250 to 20,000.

15. The method according to claim 7, wherein with a total molar amount of the lithium borohydride, the alumina, and the lithium iodide in the lithium borohydride-based solid-state electrolyte as 100%, a molar amount of the lithium borohydride is 50% to 60% of the total molar amount, a molar amount of the alumina is 20% to 25% of the total molar amount, and a molar amount of the lithium iodide is 20% to 25% of the total molar amount.

16. The method according to claim 7, wherein the polymer coating layer has a thickness of 1 nm to 100 nm.

17. The method according to claim 7, wherein the poly(methyl methacrylate) has a polymerization degree of 250 to 20,000.

18. The method according to claim 16, wherein the poly(methyl methacrylate) has a polymerization degree of 250 to 20,000.

19. The method according to claim 7, wherein the polymer coating layer is an amorphous coating layer.

20. The method according to claim 7, wherein the composite electrolyte with the wide working voltage range comprises covalent (OCH3)ₓBH₄₋ₓ.
